(19) United States
(12) Patent Application Publication
(10) Pub. No.: US 2014/0239905 A1
(43) Pub. Date: Aug. 28, 2014

(54) ELECTROCHEMICAL DEVICE

(71) Applicant: SEMICONDUCTOR ENERGY LABORATORY CO., LTD., ATSUGI-SHI (JP)

(72) Inventor: Shunpei YAMAZAKI, TOKYO (JP)

(73) Assignee: SEMICONDUCTOR ENERGY LABORATORY CO., LTD., ATSUGI-SHI (JP)

(21) Appl. No.: 14/187,562

(22) Filed: Feb. 24, 2014

(30) Foreign Application Priority Data
Feb. 28, 2013 (JP) 2013-039470

(51) Int. Cl. H01M 10/44; H02J 7/00; H01M 10/054

(52) U.S. Cl. CPC H01M 10/44; H01M 10/054; H02J 7/00
USPC 320/128; 429/122

(57) ABSTRACT

Deterioration of a battery is prevented or the degree of deterioration of a battery is reduced, and charge and discharge performance of the battery is maximized and the charge and discharge performance of the battery is maintained for a long time. In a battery such as a sodium-ion secondary battery, various malfunctions or deterioration is caused by a reaction product deposited on an electrode surface. The reaction product is dissolved by applying a signal (inversion pulse current) to make a current flow in a direction opposite to a direction in which the reaction product is formed more than once in charging or discharging.

### BACKGROUND OF THE INVENTION

1. Field of the Invention

The present invention relates to an object, a method, or a manufacturing method. In addition, the present invention relates to a process, a machine, manufacture, or a composition of matter. In particular, the present invention relates to, for example, a power storage device, a semiconductor device, a display device, a light-emitting device, a driving method thereof, or a fabrication method thereof. In particular, the present invention relates to, for example, an electrochemical device, an operating method thereof, or a fabrication method thereof. Alternatively, the present invention relates to a system having a function of reducing the degree of deterioration of an electrochemical device.

Note that an electrochemical device in this specification generally means a device that can operate by utilizing an electrochemical reaction, such as a battery or a capacitor.

2. Description of the Related Art

Batteries (secondary batteries) are known as a typical example of electrochemical devices. A lithium-ion secondary battery has been used in a variety of applications, including a power source for a mobile phone, a fixed power source for a residential power storage system, power storage equipment for a power generation facility, such as a solar cell, and a power source for a vehicle.

However, the reserve of lithium, which is necessary for the lithium-ion secondary battery, is extremely small. For this reason, as demand for lithium-ion secondary batteries grows, the price of lithium inevitably rises.

In view of the above, metal-ion secondary batteries with high output that require less or no minor metal such as lithium have been researched for cost reduction. A typical example of the metal-ion secondary batteries is a sodium-ion secondary battery (see Patent Document 1). Because of the adequate reserve of sodium, a battery with high capacity containing sodium as a raw material can be easily supplied at low cost.

### REFERENCE

### Patent Document

[Patent Document 1] PCT International Publication No. 2010/109889

### SUMMARY OF THE INVENTION

A metal-ion secondary battery such as a sodium-ion secondary battery deteriorates due to repeated charge and discharge and the capacity thereof is gradually decreased. The voltage of the battery eventually becomes lower than voltages in a range where an electronic device including the battery can be used; thus, the electronic device does not function properly.

In view of the above, an object of the present invention is to prevent deterioration of a battery or reduce the degree of deterioration of a battery and to maximize charge and discharge performance of the battery and maintain charge and discharge performance of the battery for a long time.

Batteries are electrochemical devices whose lifetimes are difficult to estimate individually in advance. Some batteries suddenly stop functioning for some reason even though they were able to be charged and discharged without any problem at the time of manufacture and were shipped as quality products.

Another object of the present invention is to prevent a battery from suddenly stopping function, and to secure and improve long-term reliability of each battery. Another object of the present invention is to provide a maintenance-free battery by solving the object. In particular, there is a problem in that the maintenance of a fixed power source or power storage equipment requires considerable cost and time.

There are also some batteries that produce heat, expand, ignite, or explode because of any cause even though they were able to be charged and discharged without any problem at the time of manufacture and were shipped as quality products. Hence, another object of the present invention is to ensure the safety of a battery.

Another object of the present invention is to enable rapid charge and rapid discharge of a battery. Another object of the present invention is to provide a novel charging method or a novel discharging method of a battery. Note that the descriptions of these objects do not disturb the existence of other objects. In one embodiment of the present invention, there is no need to achieve all the objects. Other objects will be apparent from and can be derived from the description of the specification, the drawings, the claims, and the like.

In a metal-ion secondary battery such as a sodium-ion secondary battery, a reaction product deposited on an electrode surface is a cause of various malfunctions or deterioration. The present inventor has found the following breakthrough technological idea: in an electrochemical device that operates utilizing an electrochemical reaction, typified by a sodium-ion secondary battery, application of an electrical stimulus prevents a reaction product from being deposited on an electrode in charging or discharging or dissolves the deposited reaction product.

### <Charge and Discharge of Sodium-Ion Secondary Battery>

Here, the operation principle of a sodium-ion secondary battery is described with reference to schematic diagrams in FIGS. 2A and 2B and FIG. 3.

The schematic diagram in FIG. 2A illustrates an electrochemical reaction of a sodium-ion secondary battery at the time of charging. The schematic diagram in FIG. 2B illustrates an electrochemical reaction of the sodium-ion secondary battery at the time of discharging. In FIG. 2A, a reference numeral 501 denotes a sodium-ion secondary battery, and a reference numeral 502 denotes a charger. In FIG. 2B, a reference numeral 503 denotes a load.

When the battery 501 is regarded as a closed circuit, a sodium ion moves and a current flows in the same direction as illustrated in FIGS. 2A and 2B. In a metal-ion secondary battery such as a sodium-ion secondary battery, an anode and a cathode change places in charge and discharge, and an oxidation reaction and a reduction reaction occur on the corresponding sides; hence, an electrode with a high redox potential is called a positive electrode and an electrode with a low redox potential is called a negative electrode in this specification. For this reason, in this specification, the positive electrode is referred to as a “positive electrode” and the negative electrode is referred to as a “negative electrode” regardless of the states of the battery: the states in which charge is performed, discharge is performed, an inversion pulse current (also referred to as a reverse pulse current) is supplied, a discharging current is supplied, and a charging current is supplied.

The use of the terms “anode” and “cathode” related to an oxidation reaction and a reduction reaction might cause confusion because the anode and the cathode change places at the time of charging and discharging. Thus, the terms “anode” and “cathode” are not used for electrodes of a battery in this specification. If the terms “anode” or “cathode” is used, it should be mentioned that the anode or the cathode is which of the one at the time of charging or the one at the time of discharging and corresponds to which of a positive electrode or a negative electrode.

Note that as illustrated in FIGS. 2A and 2B, the sodium-ion secondary battery 501 includes a positive electrode containing Na₂FePO₄F as a positive electrode active material and a negative electrode containing hard carbon (C_{y} and 0<y) as a negative electrode active material.

FIG. 2A shows that in the state of charge, a current is supplied from the charger 502 to cause a reaction of Formula (1) in the positive electrode of the sodium-ion secondary battery 501 (hereinafter, also referred to as the battery 501). Note that 0<x<2 and 0<y in Formulae (1) to (6).

Na₂FePO₄F→Na₍₂₋ₓ₎FePO₄F+ₓNa⁺+xe⁻ (1)

A reaction of Formula (2) occurs in the negative electrode.

xC_{y}+xNa⁺+xe⁻→xNaC_{y} (2)

Thus, the overall reaction in charging the battery 501 is expressed by Formula (3).

Na₂FePO₄F+xC_{y}→Na₍₂₋ₓ₎FePO₄F+ₓNaC_{y} (3)

As illustrated in FIG. 2B, in the state of discharge, a current is supplied to the load 503 to cause a reaction of Formula (4) in the positive electrode of the battery 501.

Na₍₂₋ₓ₎FePO₄F+xNa⁺+xe⁻→Na₂FePO₄F (4)

A reaction of Formula (5) occurs in the negative electrode.

xNaC_{y}→xC_{y}+xNa⁺+xe⁻ (5)

Thus, the overall reaction in discharging the battery 501 is expressed by Formula (6).

Na₍₂₋ₓ₎FePO₄F+ₓNaC_{y}→Na₂FePO₄F+xC_{y} (6)

The battery 501 is supposed to be charged when sodium is intercalated into hard carbon in the negative electrode, and is supposed to be discharged when the intercalated sodium dissolves in an electrolytic solution as sodium ions. However, at the time of charging or discharging, deposition of sodium might occur at the negative electrode for any reason.

### <Positive Electrode Potential and Negative Electrode Potential>

The equilibrium potentials of the positive electrode and the negative electrode are each determined by a material and an equilibrium state of the material. The potential difference (voltage) between the electrodes varies depending on the equilibrium states of the materials of the positive electrode and the negative electrode.

A positive electrode potential is an electrochemical equilibrium potential of a positive electrode active material, and a negative electrode potential is an electrochemical equilibrium potential of a negative electrode active material. Here, the potential at which a sodium metal is in electrochemical equilibrium in an electrolytic solution is denoted by 0 V (vs. Na/Na⁺), for example. When the potential of the sodium metal is higher than 0 V (vs. Na/Na⁺), Na⁺ ions dissolve from sodium into the electrolytic solution, and when the potential of the sodium metal is lower than 0 V (vs. Na/Na⁺), the Na⁺ ions in the electrolytic solution are deposited as sodium.

FIG. 3 schematically illustrates the relationship between the electrode potentials of the positive electrode and the negative electrode in the battery 501. In FIG. 3, φp denotes the electrode potential of the positive electrode, and φn denotes the electrode potential of the negative electrode. The values of the electrode potentials φp and φn are set using the potential at which sodium is in electrochemical equilibrium in the electrolytic solution as a reference potential. An arrow 505 denotes a charging voltage.

The difference between the electrode potentials of the positive electrode and the negative electrode in the battery 501 is φp−φn. The electrode potential is an electrochemical equilibrium potential of an electrode. Accordingly, when the charging voltage is φp−φn, the reaction of Formula (1) and the reaction of Formula (4) equilibrate in the positive electrode and the reaction of Formula (2) and the reaction of Formula (5) equilibrate in the negative electrode; thus, a current does not flow.

Therefore, to pass a charging current to the battery 501, the charging voltage needs to be higher than φp−φn. For example, on the assumption that a series resistance component inside the battery 501 is ignored and all extra charging voltage is used in the electrode reactions of Formulae (1) and (2), as indicated by the arrow 505, the extra charging voltage is shared by the positive electrode and the negative electrode as an overvoltage (V1) to the positive electrode and an overvoltage (V2) to the negative electrode.

To obtain a higher current density per unit electrode area (area of the active material), a higher overvoltage is necessary. For example, when the battery is rapidly charged, a current density per unit surface area of the active material needs to be high, in which case a higher overvoltage is needed.

However, as the overvoltage is raised to increase the current density per unit surface area of the active material, the overvoltage V2 to the negative electrode increases; therefore, a potential φ3 at the bottom of the charging voltage shown by the arrow 505 in FIG. 3 becomes lower than the potential of the negative electrode. Then, the reaction of Formula (7) occurs in the negative electrode. In other words, sodium is deposited on a surface of the negative electrode.

Na⁺+e⁻→Na (7)

In view of the above, in one embodiment of the present invention, a sodium-ion secondary battery in which a sodium deposit (sodium metal) does not exist substantially on a surface of a negative electrode after charging can be achieved by supply of an inversion pulse current.

In rapid charging, the potential of the negative electrode decreases and thus, sodium is more likely to be deposited. In a low-temperature environment, the resistance of the negative electrode increases, so that the potential of the negative electrode further lowers and sodium becomes more likely to be deposited accordingly. However, supply of an inversion pulse current allows rapid charge of a metal-ion secondary battery and charge of a metal-ion secondary battery in a low-temperature environment.

That is to say, one embodiment of the present invention is an electrochemical device that includes a positive electrode, a negative electrode, and an electrolytic solution. The positive electrode includes a first layer including a positive electrode active material. The negative electrode includes a second layer including a negative electrode active material. The positive electrode active material contains a metal element that is released as a positive ion in charging. The metal element is not substantially deposited on a surface of the negative electrode.

An “inversion pulse current” is used as one mode of an “electrical stimulus” applied to an electrode in order to, for example, inhibit deposition of a metal element or dissolve a deposit of a metal element.

Another embodiment of the present invention is an electrochemical device that includes a positive electrode, a negative electrode, and an electrolytic solution. The positive electrode includes a first layer including a positive electrode active material. The negative electrode includes a second layer including a negative electrode active material. Charge and discharge is performed by alternately supplying a first current that flows between the positive electrode and the negative electrode in a first direction and supplying an inversion pulse current that makes a current flow between the positive electrode and the negative electrode in the direction opposite to the first direction to the positive electrode or the negative electrode more than once. One period in which the inversion pulse current is supplied is shorter than one period in which the first current is supplied.

The period in which the inversion pulse current is supplied is longer than or equal to one hundredths of the period in which the first current is supplied and shorter than or equal to one third of the period in which the first current is supplied. Specifically, the period in which the inversion pulse current is supplied can be longer than or equal to 0.1 seconds and shorter than or equal to 3 minutes, and is typically longer than or equal to 3 seconds and shorter than or equal to 30 seconds.

The “inversion pulse current” refers to a signal that makes a current flow between a positive electrode and a negative electrode in the direction opposite to that of a current that flows between the positive electrode and the negative electrode when a battery is charged or discharged (the current is a charging current when the battery is charged, and is a discharging current when the battery is discharged). The period in which the inversion pulse current is supplied to the electrode should be shorter than the period in which the charging current or the discharging current is supplied after the previous supply of the inversion pulse current and is preferably sufficiently short. The expression “pulse” of the “inversion pulse current” refers not only a momentary flow of a current in the direction opposite to that of a charging current or a discharging current when a battery is charged or discharged but also a temporary flow of a current in the direction opposite to that of a charging current or a discharging current for a period of time that cannot be perceived as momentary by intuition (for example, for longer than or equal to 1 second).

In one embodiment of the present invention, a reaction product deposited on an electrode surface can be dissolved by applying a signal (inversion pulse current) that makes a current flow between a positive electrode and a negative electrode in the direction opposite to that of the current with which the reaction product is formed. Hence, according to the one embodiment of the present invention, the electrode surface that has changed can be restored to the initial state or the electrode surface can be prevented from changing, resulting in a battery that does not deteriorate in principle. In other words, a maintenance-free battery is achieved, which allows a device including the battery to be used for a long time.

The technological ideas of one embodiment of the present invention, which uses the mechanism of formation of a reaction product and the mechanism of dissolution of the reaction product, can provide an electrochemical device that has partly deteriorated to be repaired and restored to the initial state.

### BRIEF DESCRIPTION OF THE DRAWINGS

FIGS. 1A to 1C are schematic diagrams illustrating an example of a method for supplying an inversion pulse current, and FIG. 1D is a schematic diagram illustrating an example of a structure of an electrode in a battery.

FIGS. 2A and 2B are schematic diagrams illustrating the principle of a sodium-ion secondary battery; FIG. 2A illustrates the case of charging and FIG. 2B illustrates the case of discharging.

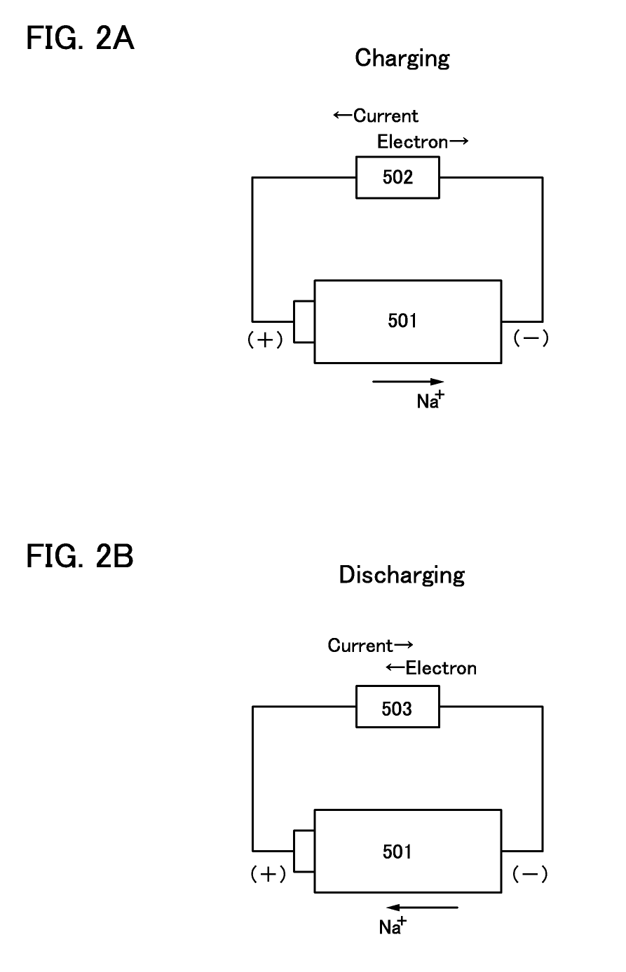

FIG. 3 is a schematic diagram illustrating the potentials of electrodes of a sodium-ion secondary battery.

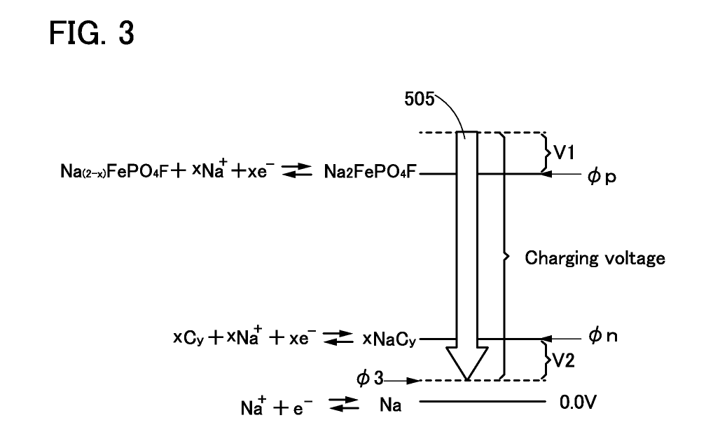

FIGS. 4A and 4B each illustrate an example of a structure of an electrochemical device.

FIGS. 5A and 5B illustrate an example of a structure of an electrochemical device.

FIGS. 6A to 6C illustrate an example of a structure of an electrochemical device.

FIGS. 7A to 7C illustrate an example of a structure of an electrical device including an electrochemical device.

FIGS. 8A and 8B illustrate an example of a structure of an electrical device including an electrochemical device.

FIGS. 9A and 9B each illustrate an example of an energy management system including an electrochemical device.

### DETAILED DESCRIPTION OF THE INVENTION

Embodiments of the present invention will be described in detail below with reference to drawings. Note that the present invention is not limited to the following description, and it is easily understood by those skilled in the art that the modes and details can be variously changed without departing from the spirit and scope of the present invention. Therefore, the present invention should not be construed as being limited to the description of the embodiments below.

Note that in the drawings used for the descriptions of the embodiments of the invention, the same portions or portions having similar functions are denoted by the common reference numerals, and repeated descriptions thereof are omitted in some cases.

### Embodiment 1

In this embodiment, a method for supplying an inversion pulse current is described.

### <Example of Method for Supplying Inversion Pulse Current>

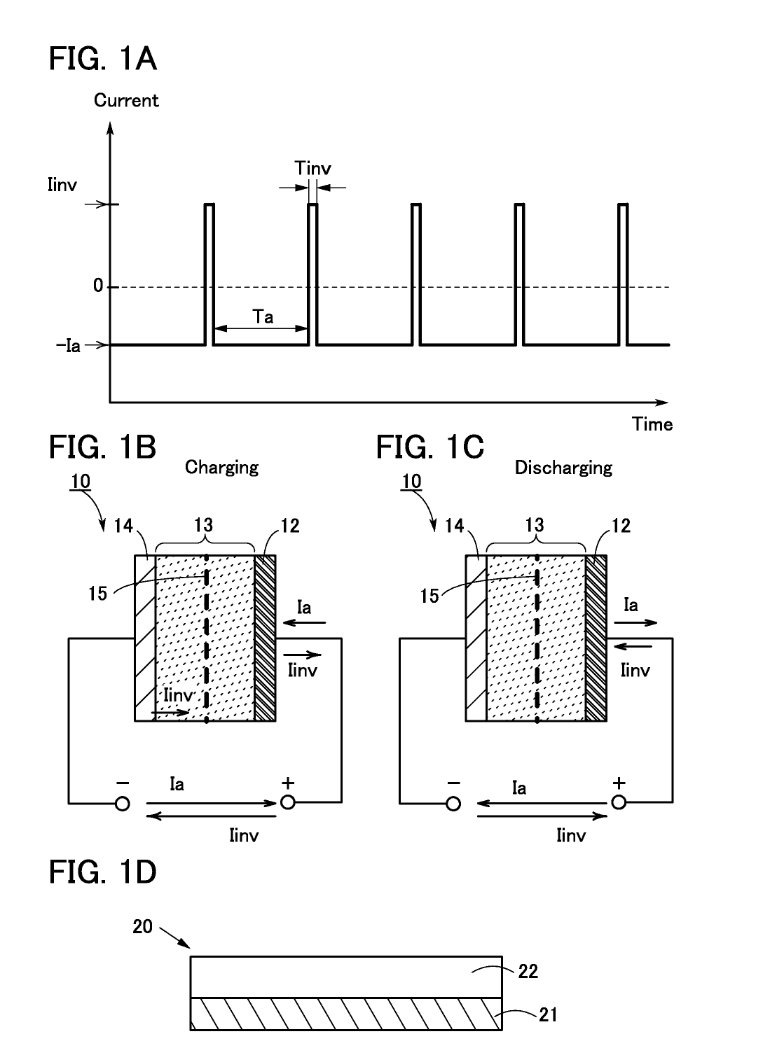

Description is given of an inversion pulse current with reference to FIGS. 1A to 1C. FIG. 1A schematically shows changes over time of current supplied to a positive electrode or a negative electrode of a battery 10 in charging or discharging the battery 10. A current Ia corresponds to a charging current when the battery 10 is charged, and corresponds to a discharging current when the battery 10 is discharged. In this embodiment, Ia is a constant current for simplicity; however, the amount of Ia may be varied depending on the condition of the battery 10. Although an inversion pulse current Iinv is also a constant current like Ia, the amount of inversion pulse current Iinv may be varied depending on the condition of the battery 10. In addition, the direction in which the inversion pulse current Iinv flows is defined as the positive direction of current in some cases. In such a case, since the inversion pulse current Iinv at the time of charging and the inversion pulse current Iinv at the time of discharging flow in opposite directions, the directions of the reference current at the time of charging and the reference current at the time of discharging are opposite to each other. Therefore, in charging and in discharging, the inversion pulse current values are positive values (Iinv), and the charging current value or the discharging current value is a negative value (−Ia).

For easy understanding of this embodiment, charge is described first. FIG. 1B illustrates the charging current Ia and the inversion pulse current Iinv supplied to the battery 10 in charging. Provided that the charging current Ia and the inversion pulse current Iinv flow in opposite directions, the current value of the inversion pulse current is a positive value (Iinv), and the current value of the charging current is also a positive value (Ia).

In the battery 10, a reference numeral 12 denotes a positive electrode, a reference numeral 13 denotes an electrolytic solution, a reference numeral 14 denotes a negative electrode, and a reference numeral 15 denotes a separator.

As illustrated in FIG. 1B, in charging the battery 10, the charging current Ia flows in the direction from the negative electrode 14 to the positive electrode 12 outside the battery 10, and flows in the direction from the positive electrode 12 to the negative electrode 14 inside the battery 10. Thus, the inversion pulse current Iinv is supplied to the negative electrode 14 or the positive electrode 12 to flow in the direction from the positive electrode 12 to the negative electrode 14 outside the battery 10, and to flow in the direction from the negative electrode 14 to the positive electrode 12 inside the battery 10. In the case of FIG. 1B, in charging, the current Ia is supplied to the positive electrode 12 from outside of the battery 10, and the inversion pulse current Iinv is supplied to outside of the battery 10 from the positive electrode 12.

As illustrated in FIG. 1C, in discharging the battery 10, the discharging current Ia flows in the direction from the positive electrode 12 to the negative electrode 14 outside the battery 10, and flows in the direction from the negative electrode 14 to the positive electrode 12 inside the battery 10. Thus, the inversion pulse current Iinv is supplied to the negative electrode 14 or the positive electrode 12 to flow in the direction from the negative electrode 14 to the positive electrode 12 outside the battery 10, and to flow in the direction from the positive electrode 12 to the negative electrode 14 inside the battery 10. In the case of FIG. 1C, in discharging, the current Ia is supplied to the negative electrode 14 from outside of the battery 10, and the inversion pulse current Iinv is supplied to outside of the battery 10 from the negative electrode 14.

Note that the expression “a current is supplied” can refer to the case where a current is supplied from a power supply source which exists outside the battery 10 and supplies electric power such as a current or a voltage, or the case where a current is supplied from the battery 10 serving as a power supply source to a load including a passive element such as a resister or a capacitor, an active element such as a transistor or a diode, or the like. The case where the battery 10 is a power supply source and supplies a current to such a load corresponds to the case of discharging the battery 10. Thus, the inversion pulse current Iinv at the time of charging the battery 10 corresponds to a current in the case of discharging the battery 10, and the inversion pulse current Iinv at the time of discharging the battery 10 corresponds to a current in the case of charging the battery 10.

As shown in FIG. 1A, in charging (discharging), the inversion pulse current Iinv is supplied to the positive electrode 12 or the negative electrode 14 repeatedly more than once in a period during which the charging (discharging) current Ia is supplied to the positive electrode 12 or the negative electrode 14. One period of time Tinv in which the inversion pulse current is supplied is shorter than one period of time Ta in which the current Ia is supplied. The period of time Tinv is set in consideration of a charging rate, a discharging rate, or the like.

The period of time Tinv in which the inversion pulse current is supplied should be, for example, longer than or equal to one hundreds of the period of time Ta in which the current Ia is supplied and shorter than or equal to one third of the period of time Ta. Specifically, given that Tinv is shorter than Ta, the period of time Tinv is preferably longer than or equal to 0.1 seconds and shorter than or equal to 3 minutes, typically longer than or equal to 3 seconds and shorter than or equal to 30 seconds.

FIG. 1A shows an example where the amount (absolute value) of inversion pulse current Iinv is greater than the amount (absolute value) of current Ia. In this embodiment, the amount of inversion pulse current Iinv can be less than or equal to the amount of current Ia as long as the inversion pulse current flows between the positive electrode and the negative electrode more than once in a period during which the current Ia is supplied.

Effects of preventing or inhibiting deterioration of a battery by supplying an inversion pulse current is described with reference to FIG. 1A. Here, the case of charging is described as an example. A charging method is a constant current charging.

First, when charge is started, a reaction product is not deposited on the surface of the negative electrode 14, that is, the battery 10 is in the initial state just after shipment. When the charging current Ia keeps being supplied to the battery 10, a reaction product is deposited on the surface of the negative electrode 14. The reaction product is, for example, a sodium metal that is deposited. Although the reaction product grows over time, supply of the inversion pulse current Iinv enables the state in which a reaction product does not exist on the surface of the negative electrode 14. When the reaction product is a sodium metal, the sodium metal is dissolved in the electrolytic solution 13 as sodium ions, for example.

Then, the supply of the inversion pulse current Iinv is stopped and the charging current Ia is supplied. When the charging current Ia is supplied, the reaction product is deposited on the surface of the negative electrode 14 again; however, the reaction product can be dissolved every time the inversion pulse current Iinv is supplied.

Thus, it is possible that the reaction product does not exist on the surface of the negative electrode 14 at the time of termination of charge, as in starting charge (at the time of shipment). That is, it is preferable that the surface of the negative electrode 14 be restored to the state where the reaction product does not exist on the surface of the negative electrode 14 by supplying the inversion pulse current Iinv once. Such charge can be performed when the amount of inversion pulse current Iinv, the period of time Tinv in which the inversion pulse current Iinv is supplied, and an interval during which the inversion pulse current is supplied (corresponding to the period of time Ta when the charging current Ia is supplied) are adjusted.

For example, as the period of time Ta in which the charging current Ia is supplied increases, the amount of the reaction product increases and thus it becomes more difficult to dissolve, and the reaction product alters or is solidified (increased in density) more significantly and thus it becomes more difficult to dissolve. Therefore, in order that the surfaces of the negative electrode 14 and the positive electrode 12 be maintained favorable, the amount of inversion pulse current Iinv, the period of time Tinv, and the period of time Ta are set as described above.

Examples of the charging method are given. The charging current is supplied for 10 minutes to 60 minutes at 0.2 C in one period, and the inversion pulse current is supplied for 1 second to 30 seconds at 1 C in one period. The rate at the time of supplying the charging current is less than 1 C, and the rate at the time of supplying the inversion pulse current is approximately 2 times to 10 times the rate at the time of supplying the charging current, for example. In other words, the amount of inversion pulse current Iinv is greater than or equal to 2 times and less than or equal to 10 times the amount of charging current Ia. One period in which the charging current is supplied is not necessarily constant; for example, charge may be performed until predetermined capacity is obtained, followed by supply of the inversion pulse current.

The unit C indicates a charging rate and a discharging rate; 1 C means the amount of current per unit weight for fully charging a battery (an evaluation cell, here) in an hour.

### <Examples of Structures of Battery>

FIG. 1B illustrates a cross section of the battery 10. The positive electrode 12 includes at least a positive electrode current collector and a positive electrode active material layer in contact with the positive electrode current collector. The negative electrode 14 includes at least a negative electrode current collector and a negative electrode active material layer in contact with the negative electrode current collector. The positive electrode active material layer faces the negative electrode active material layer, and the electrolytic solution 13 and the separator 15 are provided between the positive electrode active material layer and the negative electrode active material layer.

Structures of the positive electrode 12 and the negative electrode 14 are described with reference to FIG. 1D. FIG. 1D is a longitudinal cross-sectional diagram illustrating an example of a structure of an electrode 20. The electrode 20 corresponds to either the positive electrode 12 or the negative electrode 14. As illustrated in FIG. 1D, in the electrode 20, an active material layer 22 is provided over a current collector 21. The active material layer 22 is provided on one surface of the current collector 21 in FIG. 1D; however, the active material layer 22 may be provided on the both surfaces of the current collector 21. Further, the active material layer 22 is not necessarily formed on the entire surface of the current collector 21 on the electrolytic solution side. On the surface of the current collector 21, a region connected to an external terminal and the like are provided as appropriate.

### <Current Collector>

There is no particular limitation on the current collector 21 as long as it has high conductivity without causing a chemical change in the battery 10. The current collector 21 can be formed using a conductive material such as copper, nickel, aluminum, or stainless steel, for example. The current collector 21 can have a foil-like shape, a plate-like shape (sheet-like shape), a net-like shape, a cylindrical shape, a coil shape, a punching-metal shape, an expanded-metal shape, or the like, as appropriate. For example, the use of aluminum foil for the current collector 21 in each of the negative electrode 14 and the positive electrode 12 reduces the price of a sodium-ion secondary battery.

### <Active Material Layer>

The active material layer 22 includes at least an active material. The active material layer 22 may further include a binder for increasing adhesion of the active material, a conductive additive for increasing the conductivity of the active material layer 22, and the like in addition to the active material.

### <Positive Electrode Active Material>

In the case of using the electrode 20 as the positive electrode 12 in the battery 10, which is a sodium-ion secondary battery, a material into and from which sodium ions can be inserted and extracted can be used for an active material (hereinafter referred to as a positive electrode active material) included in the active material layer 22. Although there is no particular limitation on the positive electrode active material, an oxide including sodium and a transition metal is preferably used. Examples of the oxide include NaMn₂O₄, NaNiO₂, NaCoO₂, NaFeO₂, NaNi_{0.5}Mn_{0.5}O₂, NaCrO₂, and NaFeO₂. The examples further include fluorophosphates such as Na₂FePO₄F, Na₂VPO₄F, Na₂MnPO₄F, Na₂CoPO₄F, and Na₂NiPO₄F. Furthermore, borate such as NaFeBO₄ or Na₃Fe₂(BO₄)₃ can also be used.

Any of such substances to which a rare earth element is added may be used as the positive electrode active material. The rare earth element are Sc, Y, La, Ce, Pr, Nd, Pm, Sm, Eu, Gd, Tb, Dy, Ho, Er, Tm, Yb, and Lu. A positive electrode active material to which one or more of the elements are added can be used.

### <Negative Electrode Active Material>

In the case of using the electrode 20 as the negative electrode 14 in the battery 10, which is the sodium-ion secondary battery, the active material of the active material layer 22 is a negative electrode active material. A material into and from which sodium ions can be inserted and extracted can be used as the negative electrode active material.

Examples of the negative electrode active material include hard carbon, Sn, Pb, Sb, Na₂TiO₂, and TiO₂.

### <Binder>

As the binder, polyvinylidene fluoride (PVDF) as a typical example, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

### <Electrolytic Solution>

As an electrolyte of the electrolytic solution 13, a material that contains sodium ions, which are carrier ions, is used. Typical examples of the electrolyte include NaPF₆, NaN(SO₂CF₃)₂, NaClO₄, NaBF₄, CF₃SO₃Na, and NaAsF₆.

As a solvent of the electrolytic solution 13, a material which can transfer sodium ions is used. As the solvent of the electrolytic solution 13, an aprotic organic solvent is preferably used. Typical examples of the aprotic organic solvent include ethylene carbonate (EC), propylene carbonate, dimethyl carbonate, and diethyl carbonate (DEC), and one or more of these materials can be used.

### <Separator>

The separator 15 can be formed using an insulator such as cellulose (paper), polypropylene with pores, or polyethylene with pores.

The reaction product deposited on a surface of an electrode due to charge or discharge can be a conductor or an insulator depending on an electrode material or a liquid substance in contact with the electrode. The reaction product might change a current path, and might be a conductor to cause a short circuit or be an insulator to block the current path. For this reason, as described in this embodiment, the inversion pulse current is supplied to the battery more than once at the time of charging or at the time of discharging, whereby a state in which a reaction product does not exist on an electrode (the state at the time of shipment) can be maintained.

Specifically, in the case of a sodium-ion secondary battery, sodium might be deposited on a negative electrode, whereas lithium might be deposited on a negative electrode in the case of a lithium-ion secondary battery. Sodium is much more flammable than lithium. For this reason, supply of the inversion pulse current to prevent sodium deposition can be an important technique for practical use of sodium-ion secondary batteries.

According to one embodiment of the present invention, as well as batteries, any electrochemical device which might deteriorate due to formation of a reaction product such as a metal deposit formed due to an electrochemical reaction can be prevented from deteriorating or the degree of deterioration of the electrochemical device can be reduced, leading to improvement of long-term reliability of the electrochemical device.

### Embodiment 2

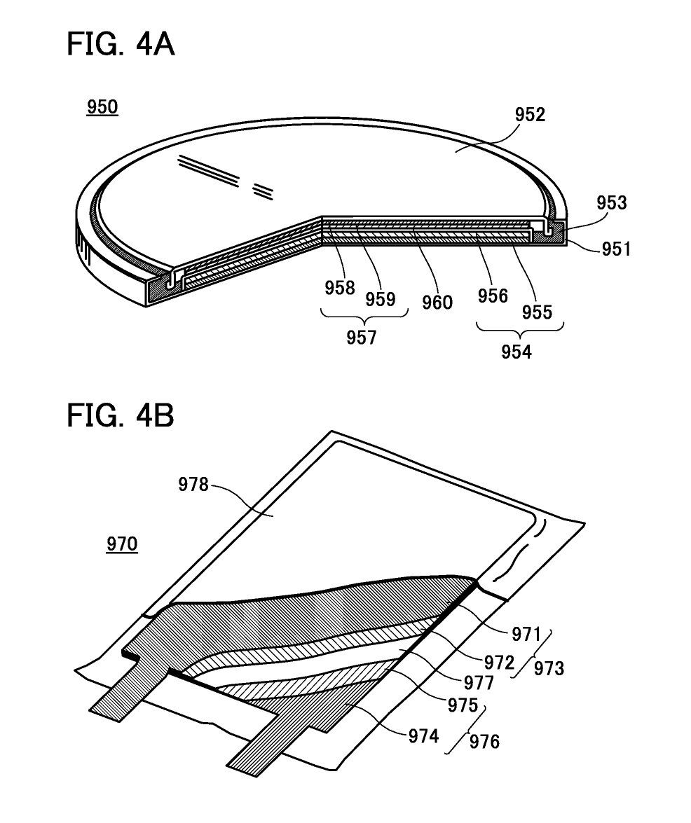

In this embodiment, structures of nonaqueous secondary batteries are described with reference to FIGS. 4A and 4B, FIGS. 5A and 5B, and FIGS. 6A to 6C.

FIG. 4A is an external view of a coin-type (single-layer flat type) battery (sodium-ion secondary battery), part of which illustrates a cross-sectional view of the coin-type battery.

In a coin-type battery 950, a positive electrode can 951 serving also as a positive electrode terminal and a negative electrode can 952 serving also as a negative electrode terminal are insulated and sealed with a gasket 953 formed of polypropylene or the like. A positive electrode 954 includes a positive electrode current collector 955 and a positive electrode active material layer 956 which is provided to be in contact with the positive electrode current collector 955. A negative electrode 957 includes a negative electrode current collector 958 and a negative electrode active material layer 959 which is provided to be in contact with the negative electrode current collector 958. A separator 960 and an electrolytic solution (not illustrated) are included between the positive electrode active material layer 956 and the negative electrode active material layer 959.

The negative electrode 957 includes the negative electrode current collector 958 and the negative electrode active material layer 959. The positive electrode 954 includes the positive electrode current collector 955 and the positive electrode active material layer 956.

For the positive electrode 954, the negative electrode 957, the separator 960, and the electrolytic solution, the above-described materials can be used.

For the positive electrode can 951 and the negative electrode can 952, a metal having corrosion resistance to an electrolytic solution, such as nickel, aluminum, or titanium, an alloy of such a metal, or an alloy of such a metal and another metal (e.g., stainless steel) can be used. Alternatively, it is preferable to cover the positive electrode can 951 and the negative electrode can 952 with nickel, aluminum, or the like in order to prevent corrosion due to the electrolytic solution. The positive electrode can 951 and the negative electrode can 952 are electrically connected to the positive electrode 954 and the negative electrode 957, respectively.

The negative electrode 957, the positive electrode 954, and the separator 960 are immersed in the electrolytic solution. Then, as illustrated in FIG. 4A, the positive electrode can 951, the positive electrode 954, the separator 960, the negative electrode 957, and the negative electrode can 952 are stacked in this order with the positive electrode can 951 positioned at the bottom, and the positive electrode can 951 and the negative electrode can 952 are subjected to pressure bonding with the gasket 953 provided therebetween. In such a manner, the coin-type battery 950 is fabricated.

Next, an example of a laminated battery (sodium-ion secondary battery) is described with reference to FIG. 4B. In FIG. 4B, a structure inside the laminated battery is partly exposed for convenience.

A laminated battery 970 illustrated in FIG. 4B includes a positive electrode 973 including a positive electrode current collector 971 and a positive electrode active material layer 972, a negative electrode 976 including a negative electrode current collector 974 and a negative electrode active material layer 975, a separator 977, an electrolytic solution (not illustrated), and an exterior body 978. The separator 977 is provided between the positive electrode 973 and the negative electrode 976 in the exterior body 978. The exterior body 978 is filled with the electrolytic solution. Although the one positive electrode 973, the one negative electrode 976, and the one separator 977 are used in FIG. 4B, the secondary battery may have a stacked-layer structure in which positive electrodes and negative electrodes are alternately stacked and separated by separators.

For the positive electrode, the negative electrode, the separator, and the electrolytic solution (an electrolyte and a solvent), the above-described materials can be used.

In the laminated battery 970 illustrated in FIG. 4B, the positive electrode current collector 971 and the negative electrode current collector 974 also serve as terminals (tabs) for an electrical contact with the outside. For this reason, the positive electrode current collector 971 and the negative electrode current collector 974 are arranged so that part of the positive electrode current collector 971 and part of the negative electrode current collector 974 are exposed outside the exterior body 978.

As the exterior body 978 in the laminated battery 970, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of an electrolytic solution and a gas can be blocked and an insulating property and resistance to the electrolytic solution can be obtained.

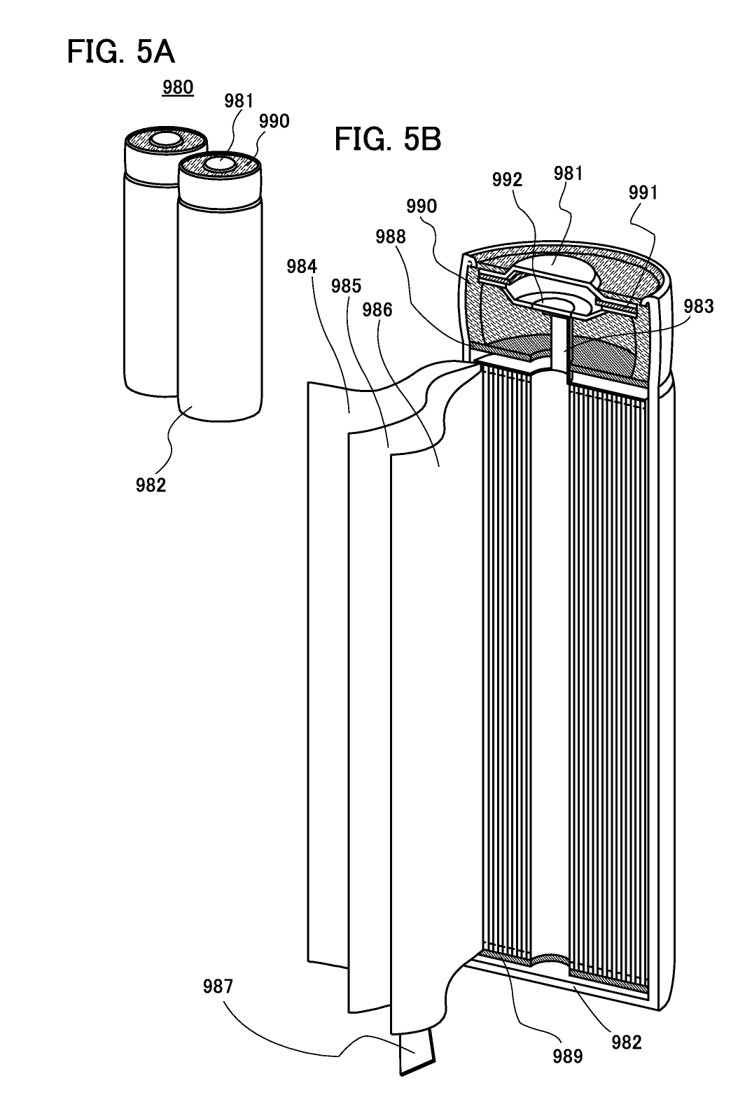

Next, an example of a cylindrical battery (sodium-ion secondary battery) is described with reference to FIGS. 5A and 5B. As illustrated in FIG. 5A, a cylindrical battery 980 includes a positive electrode cap (battery lid) 981 on the top surface and a battery can (outer can) 982 on the side surface and bottom surface. The positive electrode cap 981 and the battery can 982 are insulated by the gasket 990 (insulating packing).

FIG. 5B is a schematic view of a cross-section of the cylindrical battery 980. Inside the battery can 982 having a hollow cylindrical shape, a battery element in which a strip-like positive electrode 984 and a strip-like negative electrode 986 are wound with a separator 985 positioned therebetween is provided. Although not illustrated, the battery element is wound around a center pin. One end of the battery can 982 is close and the other end thereof is open.

For the positive electrode 984, the negative electrode 986, and the separator 985, any of the above-described materials can be used.

A metal having corrosion resistance to an electrolytic solution, such as nickel, aluminum, or titanium, an alloy of such a metal, or an alloy of such a metal and another metal (e.g., stainless steel) can be used for the battery can 982. Alternatively, the battery can 982 is preferably covered with nickel, aluminum, or the like in order to prevent corrosion caused by the electrolytic solution. Inside the battery can 982, the battery element in which the positive electrode, the negative electrode, and the separator are wound is positioned between a pair of insulating plates 988 and 989 which face each other.

Further, an electrolytic solution (not illustrated) is injected inside the battery can 982 in which the battery element is provided. For the electrolytic solution, any of the above-described electrolytes and solvents can be used.

Since the positive electrode 984 and the negative electrode 986 of the cylindrical battery 980 are wound, active material layers are formed on both sides of the current collectors. A positive electrode terminal (positive electrode current collecting lead) 983 is connected to the positive electrode 984, and a negative electrode terminal (negative electrode current collecting lead) 987 is connected to the negative electrode 986. Both the positive electrode terminal 983 and the negative electrode terminal 987 can be formed using a metal material such as aluminum. The positive electrode terminal 983 and the negative electrode terminal 987 are resistance-welded to a safety valve mechanism 992 and the bottom of the battery can 982, respectively. The safety valve mechanism 992 is electrically connected to the positive electrode cap 981 through a positive temperature coefficient (PTC) element 991. The safety valve mechanism 992 cuts off electrical connection between the positive electrode cap 981 and the positive electrode 984 when the internal pressure of the battery 980 increases and exceeds a predetermined threshold value. The PTC element 991 is a heat sensitive resistor whose resistance increases as temperature rises, and controls the amount of current by an increase in resistance to prevent unusual heat generation of the battery 980. Barium titanate (BaTiO₃)-based semiconductor ceramic or the like can be used for the PTC element 991.

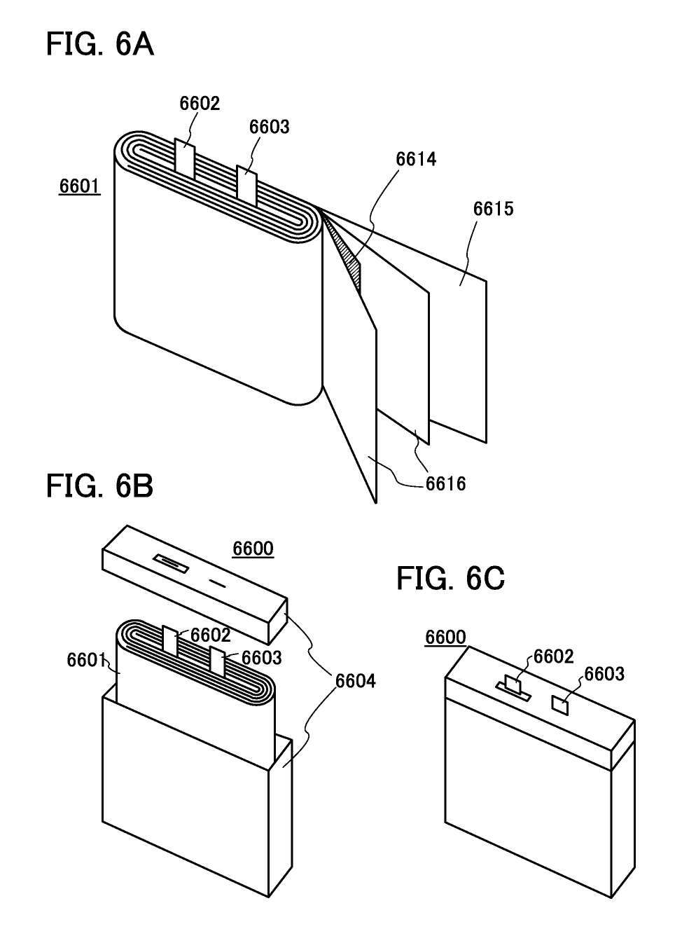

Next, an example of a rectangular secondary battery (sodium-ion secondary battery) is described with reference to FIG. 6A. A wound body 6601 illustrated in FIG. 6A includes a terminal 6602 and a terminal 6603. The wound body 6601 is obtained by winding a sheet of a stack in which a negative electrode 6614 overlaps with a positive electrode 6615 with a separator 6616 provided therebetween. The wound body 6601 is covered with a rectangular sealing can 6604 or the like as illustrated in FIG. 6B; thus, a rectangular battery 6600 is fabricated. Note that the number of stacks each including the negative electrode 6614, the positive electrode 6615, and the separator 6616 may be determined as appropriate depending on required capacity of the battery 6660 and the volume of the sealing can 6604. FIG. 6C illustrates the sealing can 6604 that is closed.

This embodiment can be freely combined with any of the other embodiments. Specifically, a signal (an inversion pulse current) is applied to an electrochemical device such as a battery of this embodiment so that a current flows in the direction opposite to that of a current with which a reaction product is formed, thereby dissolving the reaction product. As a result, deterioration of the electrochemical device can be prevented or the degree of deterioration of the electrochemical device can be reduced, and the charge and discharge performance of the electrochemical device can be maximized to be maintained for a long time. In addition, the application of a signal (an inversion pulse current) to the electrochemical device of this embodiment to make a current flow in the direction opposite to that of a current with which a reaction product is formed, results in elimination of electrochemical devices that suddenly stop functioning as batteries for some reason even though they were able to be charged and discharged without any problem at the time of manufacture and were shipped as quality products.

### Embodiment 3

The electrochemical device of one embodiment of the present invention can be used for power storage devices as power sources of a variety of electrical devices. Further, according to one embodiment of the present invention, a maintenance-free battery can be achieved by applying a signal to an electrochemical device to make a current flow in the direction opposite to that of a current with which a reaction product is formed.

Here, “electrical devices” refer to all general industrial products including portions which operate by electric power. Electrical devices are not limited to consumer products such as home electrical products and also include products for various uses such as business use, industrial use, and military use in their category. Examples of electrical devices each using the electrochemical device of one embodiment of the present invention are as follows: display devices of televisions, monitors, and the like, lighting devices, desktop personal computers, laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, remote controls, clocks such as table clocks and wall clocks, cordless phone handsets, transceivers, mobile phones, car phones, portable or stationary game machines, pedometers, calculators, portable information terminals, electronic notebooks, e-book readers, electronic translators, audio input devices such as microphones, cameras such as still cameras and video cameras, toys, electric shavers, electric toothbrushes, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and a health equipment and a medical equipment such as hearing aids, cardiac pacemakers, portable X-ray equipment, radiation counters, electric massagers, and dialyzers. The examples also include industrial equipment such as guide lights, traffic lights, meters such as gas meters and water meters, belt conveyors, elevators, escalators, automatic vending machines, automatic ticket machine, cash dispensers (CD), automated teller machines (ATM), digital signage, industrial robots, radio relay stations, mobile phone base stations, power storage systems, and power storage devices for leveling the amount of power supply and smart grid.

In the electrical devices, the electrochemical device of one embodiment of the present invention can be used as a main power source for supplying enough electric power for almost the whole power consumption. Alternatively, in the above electrical devices, the electrochemical device of one embodiment of the present invention can be used as an uninterruptible power source which can supply electric power to the electrical devices when the supply of electric power from the main power source or a commercial power source is stopped. Further alternatively, in the electrical devices, the electrochemical device of one embodiment of the present invention can be used as an auxiliary power source for supplying electric power to the electrical devices at the same time as the power supply from the main power source or a commercial power source. When the electrochemical device of one embodiment of the present invention is used for as an auxiliary power source, a maintenance-free battery can be achieved by applying a signal (inversion pulse current) to the electrochemical device of this embodiment to make a current flow in the direction opposite to that a current with which a reaction product is formed, resulting in a reduction in cost and time which are required for the maintenance of a fixed power source or power storage equipment. Although the maintenance of the fixed power source or power storage equipment requires considerable cost, a significant effect, such as a great reduction in cost for the maintenance, can be obtained by applying a signal (inversion pulse current) to the electrochemical device of this embodiment to make a current flow in the direction opposite to that of a current with which a reaction product is formed.

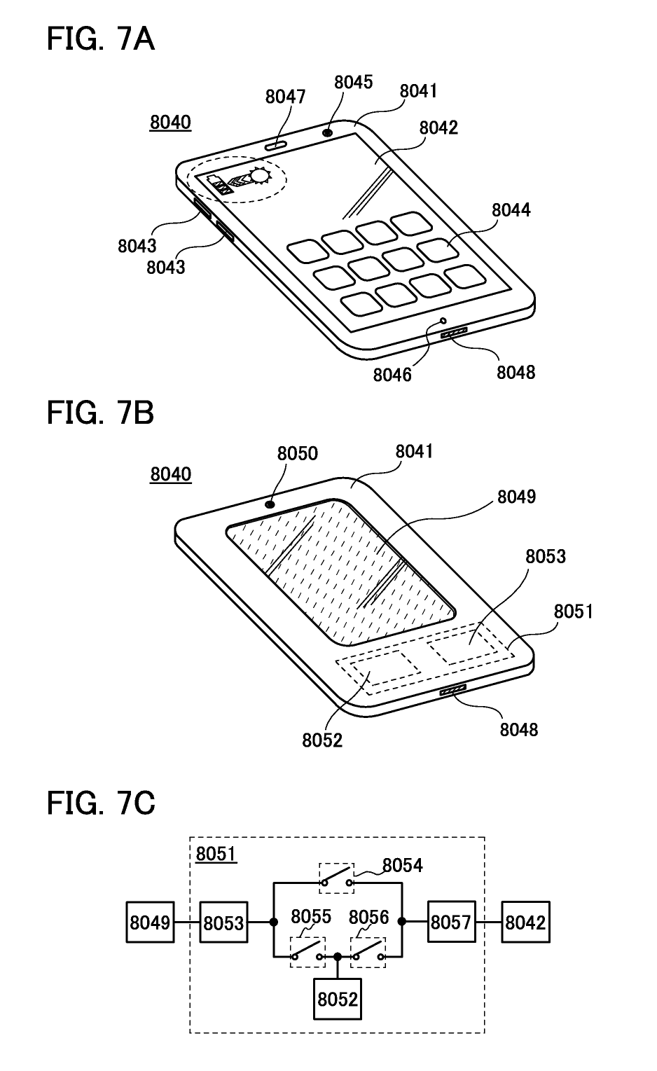

Next, as another example of the electrical devices, a portable information terminal is described with reference to FIGS. 7A to 7C.

FIG. 7A is a perspective view illustrating a front surface and a side surface of a portable information terminal 8040. The portable information terminal 8040 is capable of executing a variety of applications such as mobile phone calls, e-mailing, viewing and editing texts, music reproduction, Internet communication, and a computer game. In the portable information terminal 8040, a housing 8041 includes a display portion 8042, a camera 8045, a microphone 8046, and a speaker 8047 on its front surface, a button 8043 for operation on its left side, and a connection terminal 8048 on its bottom surface.

A display module or a display panel is used for the display portion 8042. Examples of the display module or the display panel are a light-emitting device in which each pixel includes a light-emitting element typified by an organic light-emitting element (OLED); a liquid crystal display device; an electronic paper performing a display in an electrophoretic mode, an electronic liquid powder (registered trademark) mode, or the like; a digital micromirror device (DMD); a plasma display panel (PDP); a field emission display (FED); a surface conduction electron-emitter display (SED); a light-emitting diode (LED) display; a carbon nanotube display; a nanocrystal display; and a quantum dot display.

The portable information terminal 8040 illustrated in FIG. 7A is an example of providing the one display portion 8042 in the housing 8041; however, one embodiment of the present invention is not limited to this example. The display portion 8042 may be provided on a rear surface of the portable information terminal 8040. Further, the portable information terminal 8040 may be a foldable portable information terminal in which two or more display portions are provided.

A touch panel with which data can be input by an instruction means such as a finger or a stylus is provided as an input means on the display portion 8042. Therefore, icons 8044 displayed on the display portion 8042 can be easily operated by the instruction means. Since the touch panel is provided, a region for a keyboard on the portable information terminal 8040 is not needed and thus the display portion can be provided in a large region. Further, since data can be input with a finger or a stylus, a user-friendly interface can be obtained. Although the touch panel may be of any of various types such as a resistive type, a capacitive type, an infrared ray type, an electromagnetic induction type, and a surface acoustic wave type, the resistive type or the capacitive type is particularly preferable because the display portion 8042 of one embodiment of the present invention can be curved. Furthermore, such a touch panel may be what is called an in-cell touch panel, in which a touch panel is integral with the display module or the display panel.

The touch panel may also function as an image sensor. In this case, for example, an image of a palm print, a fingerprint, or the like is taken with the display portion 8042 touched with the palm or the finger, whereby personal authentication can be performed. Furthermore, with the use of backlight or a sensing light source emitting near-infrared light for the display portion 8042, an image of a finger vein, a palm vein, or the like can also be taken.

Further, instead of the touch panel, a keyboard may be provided in the display portion 8042. Furthermore, both the touch panel and the keyboard may be provided.

The button 8043 for operation can have various functions in accordance with the intended use. For example, the button 8043 may be used as a home button so that a home screen is displayed on the display portion 8042 by pressing the button 8043. Further, the portable information terminal 8040 may be configured such that main power source thereof is turned off with a press of the button 8043 for a predetermined time. A structure may also be employed in which a press of the button 8043 brings the portable information terminal 8040 which is in a sleep mode out of the sleep mode. Besides, the button can be used as a switch for starting a variety of functions, for example, depending on the length of time for pressing or by pressing the button at the same time as another button.

Further, the button 8043 may be used as a volume control button or a mute button to have a function of adjusting the volume of the speaker 8047 for outputting sound, for example. The speaker 8047 outputs various kinds of sound, examples of which are sound set for predetermined processing, such as startup sound of an operating system (OS), sound from sound files executed in various applications, such as music from music reproduction application software, and an incoming e-mail alert. Although not illustrated, a connector for outputting sound to a device such as headphones, earphones, or a headset may be provided together with or instead of the speaker 8047 for outputting sound.

As described above, the button 8043 can have various functions. Although the number of the button 8043 is two in the portable information terminal 8040 in FIG. 7A, it is needless to say that the number, arrangement, position, or the like of the buttons is not limited to this example and can be designed as appropriate.

The microphone 8046 can be used for sound input and recording. Images obtained with the use of the camera 8045 can be displayed on the display portion 8042.

In addition to the operation with the touch panel provided on the display portion 8042 or the button 8043, the portable information terminal 8040 can be operated by recognition of user's movement (gesture) (also referred to as gesture input) using the camera 8045, a sensor provided in the portable information terminal 8040, or the like. Alternatively, with the use of the microphone 8046, the portable information terminal 8040 can be operated by recognition of user's voice (also referred to as voice input). By introducing a natural user interface (NUI) technique, which enables data to be input to an electrical device by natural behavior of a human, the operational performance of the portable information terminal 8040 can be further improved.

The connection terminal 8048 is a terminal for inputting a signal at the time of communication with an external device or inputting electric power at the time of power supply. For example, the connection terminal 8048 can be used for connecting an external memory drive to the portable information terminal 8040. Examples of the external memory drive are storage medium drives such as an external hard disk drive (HDD), a flash memory drive, a digital versatile disc (DVD) drive, a DVD-recordable (DVD-R) drive, a DVD-rewritable (DVD-RW) drive, a compact disc (CD) drive, a compact disc recordable (CD-R) drive, a compact disc rewritable (CD-RW) drive, a magneto-optical (MO) disc drive, a floppy disk drive (FDD), and other nonvolatile solid state drive (SSD) devices. Although the portable information terminal 8040 has the touch panel on the display portion 8042, a keyboard may be provided on the housing 8041 instead of the touch panel or may be externally added.

Although the number of the connection terminal 8048 is one in the portable information terminal 8040 in FIG. 7A, it is needless to say that the number, arrangement, position, or the like of the connection terminals is not limited to this example and can be designed as appropriate.

FIG. 7B is a perspective view illustrating the rear surface and the side surface of the portable information terminal 8040. In the portable information terminal 8040, the housing 8041 includes a solar cell 8049 and a camera 8050 on its rear surface; the portable information terminal 8040 further includes a charge and discharge control circuit 8051, a power storage device 8052, a DC-DC converter 8053, and the like. FIG. 7B illustrates an example where the charge and discharge control circuit 8051 includes the power storage device 8052 and the DC-DC converter 8053. The electrochemical device of one embodiment of the present invention described above is used as the power storage device 8052.

The solar cell 8049 attached on the rear surface of the portable information terminal 8040 can supply electric power to the display portion, the touch panel, a video signal processor, and the like. Note that the solar cell 8049 can be provided on one or both surfaces of the housing 8041. By including the solar cell 8049 in the portable information terminal 8040, the power storage device 8052 in the portable information terminal 8040 can be charged even in a place where an electric power supply unit is not provided, such as outdoors.

As the solar cell 8049, it is possible to use any of the following: a silicon-based solar cell including a single layer or a stacked layer of single crystal silicon, polycrystalline silicon, microcrystalline silicon, or amorphous silicon; an InGaAs-based, GaAs-based, CIS-based, Cu₂ZnSnS₄-based, or CdTe—CdS-based solar cell; a dye-sensitized solar cell including an organic dye; an organic thin film solar cell including a conductive polymer, fullerene, or the like; a quantum dot solar cell having a pin structure in which a quantum dot structure is formed in an i-layer with silicon or the like; and the like.

Here, an example of a structure and operation of the charge and discharge control circuit 8051 illustrated in FIG. 7B is described with reference to a block diagram in FIG. 7C.

FIG. 7C illustrates the solar cell 8049, the power storage device 8052, the DC-DC converter 8053, a converter 8057, a switch 8054, a switch 8055, a switch 8056, and the display portion 8042. The power storage device 8052, the DC-DC converter 8053, the converter 8057, and the switches 8054 to 8056 correspond to the charge and discharge control circuit 8051 in FIG. 7B.

The voltage of electric power generated by the solar cell 8049 with the use of external light is raised or lowered by the DC-DC converter 8053 to be at a level needed for charging the power storage device 8052. When electric power from the solar cell 8049 is used for the operation of the display portion 8042, the switch 8054 is turned on and the voltage of the electric power is raised or lowered by the converter 8057 to a voltage needed for operating the display portion 8042. In addition, when display on the display portion 8042 is not performed, the switch 8054 is turned off and the switch 8055 is turned on so that the power storage device 8052 may be charged.

Although the solar cell 8049 is described as an example of a power generation means, the power generation means is not particularly limited thereto, and the power storage device 8052 may be charged by another power generation means such as a piezoelectric element or a thermoelectric conversion element (Peltier element). The charging method of the power storage device 8052 in the portable information terminal 8040 is not limited thereto, and the connection terminal 8048 may be connected to a power source to perform charge, for example. The power storage device 8052 may be charged by a non-contact power transmission module which performs charge by transmitting and receiving power wirelessly (without contact), or any of the above charging methods may be used in combination.

Here, the state of charge (SOC) of the power storage device 8052 is displayed on the upper left corner (in the dashed frame in FIG. 7A) of the display portion 8042. Thus, the user can check the state of charge of the power storage device 8052 and can accordingly switch the operation mode of the portable information terminal 8040 to a power saving mode. When the user selects the power saving mode, for example, the button 8043 or the icons 8044 can be operated to switch the components of the portable information terminal 8040, e.g., the display module or the display panel, an arithmetic unit such as CPU, and a memory, to the power saving mode. Specifically, in each of the components, the use frequency of a given function is decreased to stop the use. Further, the portable information terminal 8040 can be configured to be automatically switched to the power saving mode depending on the state of charge. Furthermore, by providing a sensor such as an optical sensor in the portable information terminal 8040, the amount of external light at the time of using the portable information terminal 8040 is sensed to optimize display luminance, which makes it possible to reduce the power consumption of the power storage device 8052.

In addition, when charging with the use of the solar cell 8049 or the like is performed, an image or the like showing that the charging is performed with the solar cell may be displayed on the upper left corner (in the dashed frame) of the display portion 8042 as illustrated in FIG. 7A.

It is needless to say that one embodiment of the present invention is not limited to the electrical device illustrated in FIGS. 7A to 7C as long as the electrochemical device of one embodiment of the present invention is included.

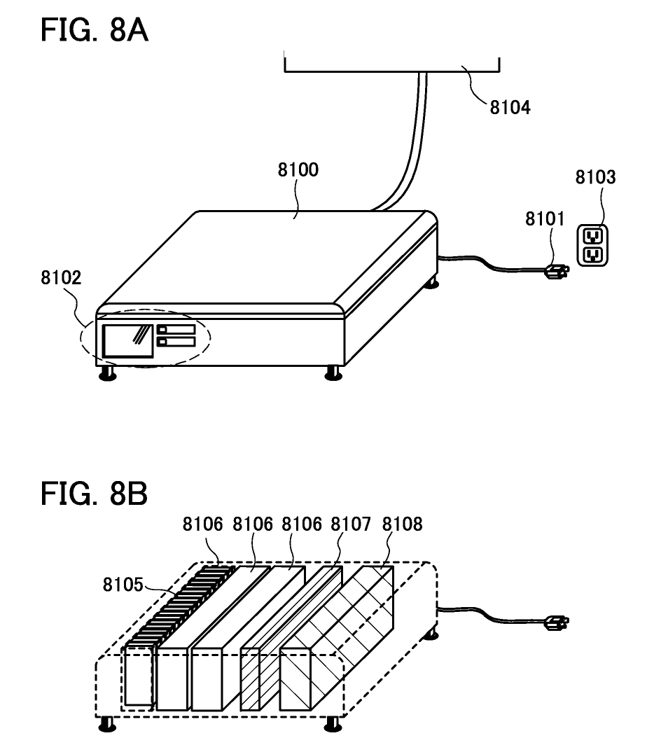

In addition, as another example of the electrical devices, a power storage system is described with reference to FIGS. 8A and 8B. A power storage device 8100 to be described here can be used at home as a power storage device 8000 described later. Here, the power storage device 8100 is described as a home-use power storage system as an example; however, it is not limited thereto and can also be used for business use or other uses.

As illustrated in FIG. 8A, the power storage device 8100 includes a plug 8101 for being electrically connected to a system power supply 8103. Further, the power storage device 8100 is electrically connected to a panelboard 8104 installed in home.

The power storage device 8100 may further include a display panel 8102 for displaying an operation state or the like, for example. The display panel may have a touch screen. In addition, the power storage device 8100 may include a switch for turning on and off a main power source, a switch to operate the power storage system, and the like as well as the display panel.

Although not illustrated, an operation switch to operate the power storage device 8100 may be provided separately from the power storage device 8100; for example, the operation switch may be provided on a wall in a room. Alternatively, the power storage device 8100 may be connected to a personal computer, a server, or the like provided in home, in order to be operated indirectly. Still alternatively, the power storage device 8100 may be remotely operated using the Internet, an information terminal such as a smartphone, or the like. In such cases, a mechanism that performs wired or wireless communication between the power storage device 8100 and other devices is provided in the power storage device 8100.

FIG. 8B is a schematic view illustrating the inside of the power storage device 8100. The power storage device 8100 includes a plurality of battery groups 8106, a battery management unit (BMU) 8107, and a power conditioning system (PCS) 8108.

In the battery group 8106, a plurality of batteries 8105 are connected to each other. Electric power from the system power supply 8103 can be stored in the battery group 8106. The plurality of battery groups 8106 are each electrically connected to the BMU 8107.

The BMU 8107 has functions of monitoring and controlling states of the plurality of batteries 8105 in the battery group 8106 and protecting the batteries 8105. Specifically, the BMU 8107 collects data of cell voltages and cell temperatures of the plurality of batteries 8105 in the battery group 8106, monitors overcharge and overdischarge, monitors overcurrent, controls a cell balancer, manages the deterioration condition of a battery, calculates the remaining battery level (the state of charge (SOC)), controls a cooling fan of a driving power storage device, or controls detection of failure, for example. Note that the batteries 8105 may have some of or all the functions, or the battery groups 8106 may have the functions. The BMU 8107 is electrically connected to the PCS 8108.

Overcharge means that charge is further performed in a state of full charge, and overdischarge means that discharge is further performed to the extent that the capacity is reduced so that operation becomes impossible. Overcharge can be prevented by monitoring the voltage of a battery during charge so that the voltage does not exceed a specified value (allowable value), for example. Overdischarge can be prevented by monitoring the voltage of a battery during discharge so that the voltage does not become lower than a specified value (allowable value).

Overcurrent refers to a current exceeding a specified value (allowable value). Overcurrent of a battery is caused when a positive electrode and a negative electrode are short-circuited in the battery or the battery is under an extremely heavy load, for example. Overcurrent can be prevented by monitoring a current flowing through a battery.

The PCS 8108 is electrically connected to the system power supply 8103, which is an AC power source and performs DC-AC conversion. For example, the PCS 8108 includes an inverter, a system interconnection protective device that detects irregularity of the system power supply 8103 and terminates its operation, and the like. In charging the power storage device 8100, for example, AC power from the system power supply 8103 is converted into DC power and transmitted to the BMU 8107. In discharging the power storage device 8100, electric power stored in the battery group 8106 is converted into AC power and supplied to an indoor load, for example. Note that the electric power may be supplied from the power storage device 8100 to the load through the panelboard 8104 as illustrated in FIG. 8A or may be directly supplied from the power storage device 8100 through wired or wireless transmission.

Each of the above electrical devices does not necessarily include a power storage device; a plurality of electrical devices, a power storage device, and a control device that controls the electric power system of these devices may be connected to one another in a wired or wireless way, which provides a network system (electric power network system) for controlling the supply of electric power. The electric power network controlled by the control device can improve usage efficiency of electric power in the whole network.

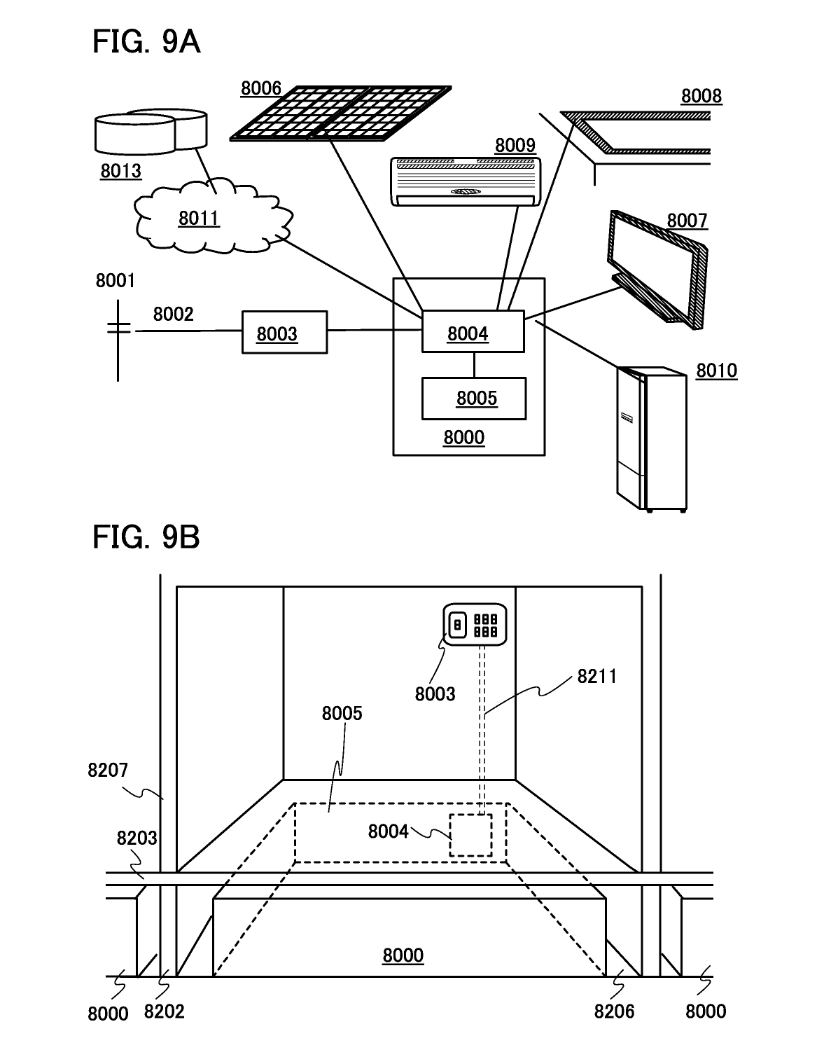

FIG. 9A illustrates an example of a home energy management system (ITEMS) in which a plurality of home appliances, a control device, a battery, and the like are connected in a house. Such a system makes it possible to check the power consumption of the whole house easily. In addition, the plurality of home appliances can be operated with a remote control. Further, automatic control of the home appliances with a sensor or the control device can also contribute to low power consumption.

The power storage device 8000 includes a management device 8004 and a battery 8005.

A panelboard 8003 set in a house is connected to an electric power system 8001 through a service wire 8002. The panelboard 8003 supplies AC power which is electric power supplied from a commercial power source through the service wire 8002 to each of the plurality of home appliances. The management device 8004 is connected to the panelboard 8003 and also connected to the plurality of home appliances, the power storage device 8000, a solar power generation system 8006, and the like.

The management device 8004 connects the panelboard 8003 to the plurality of home appliances to form a network, and controls and manages the operation of the plurality of home appliances connected to the network.

In addition, the management device 8004 is connected to Internet 8011 and thus can be connected to a management server 8013 through the Internet 8011. The management server 8013 receives data on the status of electric power usage of users and therefore can create a database and can provide the users with a variety of services based on the database. Further, as needed, the management server 8013 can provide the users with data on electric power charge for a corresponding time zone, for example. On the basis of the data, the management device 8004 can set an optimized usage pattern in the house.

Examples of the plurality of home appliances are a display device 8007, a lighting device 8008, an air-conditioning system 8009, and an electric refrigerator 8010 illustrated in FIG. 9A. However, it is needless to say that the plurality of home appliances are not limited to these examples and refer to a variety of electrical devices that can be set inside a house, such as the above electrical devices.

In a display portion of the display device 8007, a semiconductor display device such as a liquid crystal display device, a light-emitting device including a light-emitting element, e.g., an organic electroluminescent (EL) element, in each pixel, an electrophoretic display device, a digital micromirror device (DMD), a plasma display panel (PDP), or a field emission display (FED) is provided, for example. A display device functioning as a display device for displaying information, such as a display device for TV broadcast reception, a personal computer, advertisement, or the like, is included in the category of the display device 8007.

The lighting device 8008 includes an artificial light source which generates light artificially by utilizing electric power in its category. Examples of the artificial light source are an incandescent lamp, a discharge lamp such as a fluorescent lamp, and light-emitting elements such as a light-emitting diode (LED) and an organic EL element. Although being provided on a ceiling in FIG. 9A, the lighting device 8008 may be installation lighting provided on a wall, a floor, a window, or the like or desktop lighting.

The air-conditioning system 8009 has a function of adjusting an indoor environment such as temperature, humidity, and air cleanliness. FIG. 9A illustrates an air conditioner as an example. The air conditioner includes an indoor unit in which a compressor, an evaporator, and the like are integrated and an outdoor unit (not illustrated) in which a condenser is incorporated, or an integral unit thereof.

The electric refrigerator 8010 is an electrical device for the storage of food and the like at low temperature and includes a freezer for freezing at 0° C. or lower. A refrigerant in a pipe which is compressed by a compressor absorbs heat when vaporized, and thus inside the electric refrigerator 8010 is cooled.

The plurality of home appliances may each include a battery or may use electric power supplied from the battery 8005 or a commercial power source without including the battery. By using a power storage device as an uninterruptible power source, the plurality of home appliances each including the power storage device 8000 can be used even when electric power cannot be supplied from the commercial power source due to power failure or the like.

In the vicinity of a terminal for power supply in each of the above-described home appliances, an electric power sensor such as a current sensor can be provided. Data obtained with the electric power sensor is sent to the management device 8004, which makes it possible for users to check the amount of electric power used in the whole house. In addition, on the basis of the data, the management device 8004 can determine the distribution of electric power to be supplied to the plurality of home appliances, resulting in the efficient or economical use of electric power in the house.

In a time zone when the usage rate of electric power which can be supplied from the commercial power source is low, electric power is preferably stored in the battery 8005 from the commercial power source. In addition, the battery 8005 is preferably charged from the commercial power source in the nighttime, which is a time zone when electricity cost is low. Further, with the use of the solar power generation system 8006, the battery 8005 can be charged. Note that an object which is charged is not limited to the battery 8005 in the power storage device 8000, and a battery mounted on another device such as a home appliance may be the object which is charged.

Electric power stored in a variety of power sources such as the battery 8005 in such a manner is efficiently distributed by the management device 8004, resulting in the efficient or economical use of electric power in the house.

Further, the power storage device 8000 is stored in a space other than a room of the house as illustrated in FIG. 9B, whereby a living space is not consumed by the power storage device 8000. Note that the power storage device 8000 itself or an installation site thereof is made to have resistance against fire and water to secure high level of safety of the power storage device 8000.

In a building such as a housing, an underfloor space 8206 is surrounded by a base 8202 and a floor 8203 as illustrated in FIG. 9B. The inside of the house is partitioned by an inner wall 8207. The power storage device 8000 is stored in the underfloor space 8206. In the case where there are a plurality of underfloor spaces 8206 surrounded by the base 8202, the power storage devices 8000 can be stored in the respective underfloor spaces 8206. The management device 8004 of the power storage device 8000 is connected to the panelboard 8003 through a wiring 8211.

An inversion pulse current is supplied to the battery 8005 in the power storage device 8000 in charging or discharging; thus, when measures to prevent heat generation and ignition due to a short circuit of the battery 8005 are taken for such a space as the underfloor space 8206, the power storage device 8000 can be installed in the space.

This embodiment can be implemented combining with any of the other embodiments as appropriate.

This application is based on Japanese Patent Application serial No. 2013-039470 filed with Japan Patent Office on Feb. 28, 2013, the entire contents of which are hereby incorporated by reference.

What is claimed is:

1. A method for charging or discharging a sodium-ion secondary battery comprising the steps of:
supplying a first current between a first electrode and a second electrode in a first direction; and
supplying a second current between the first electrode and the second electrode in a direction opposite to the first direction,
wherein charge or discharge is performed by alternately supplying the first current and the second current, and
wherein one period in which the second current is supplied is shorter than one period in which the first current is supplied.

2. The method according to claim 1,
wherein a reaction product is deposited on a surface of the first electrode or the second electrode by supplying the first current, and
wherein the reaction product is dissolved by supplying the second current.

3. The method according to claim 2,
wherein the reaction product is sodium metal.

4. The method according to claim 1,
wherein the period in which the second current is supplied is longer than or equal to 0.1 seconds and shorter than or equal to 3 minutes.

5. The method according to claim 1,
wherein an amount of the second current is 2 times to 10 times greater than an amount of the first current.

6. The method according to claim 1,
wherein the sodium-ion secondary battery is included in an electrical device.

7. A method for maintaining a battery, the battery comprising:
a first electrode; and
a second electrode,
wherein the first electrode or the second electrode comprises sodium,
the method comprising:
supplying a first current between the first electrode and the second electrode in a first direction; and
supplying a second current between the first electrode and the second electrode in a direction opposite to the first direction,
wherein charge or discharge is performed by alternately supplying the first current and the second current, and
wherein one period in which the second current is supplied is shorter than one period in which the first current is supplied.

8. The method according to claim 7,
wherein a reaction product is deposited on a surface of the first electrode or the second electrode by supplying the first current, and
wherein the reaction product is dissolved by supplying the second current.

9. The method according to claim 8,
wherein the reaction product is sodium metal.

10. The method according to claim 7,
wherein the period in which the second current is supplied is longer than or equal to 0.1 seconds and shorter than or equal to 3 minutes.

11. The method according to claim 7,
wherein an amount of the second current is 2 times to 10 times greater than an amount of the first current.

12. The method according to claim 7,
wherein the battery is in a power storage device stored in an underfloor space of a building.

13. A sodium-ion secondary battery comprising:
a positive electrode; and
a negative electrode,
wherein a sodium deposit does not substantially exist on a surface of the negative electrode after charge and discharge.

14. The sodium-ion secondary battery according to claim 13,
wherein the sodium-ion secondary battery is in a power storage device stored in an underfloor space of a building.
